(19) United States
(12) Patent Application Publication
(10) Pub. No.: US 2004/0223206 A1
(43) Pub. Date: Nov. 11, 2004

(54) Optical lithography using both photomask surfaces

(76) Inventor: Mark C. Peterman, Jackson, WY (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/776,685

(22) Filed: Feb. 10, 2004

Related U.S. Application Data
(60) Provisional application No. 60/447,509, filed on Feb. 14, 2003.

(51) Int. Cl. G02B 26/02

(52) U.S. Cl. 359/234; 359/227

(57) ABSTRACT

A method for performing optical lithography is provided. Light is transmitted through a photomask to impinge on a target. The photomask has two mask patterns on two opposing mask surfaces separated by a transparent substrate. Light is transmitted through the first mask pattern and propagates to the second mask pattern, thereby forming a propagation pattern at that location. Light from the propagation pattern is transmitted through the second mask pattern and impinges on the target, thereby creating a target pattern. With this method, the target pattern can be changed without changing either of the mask patterns. Also, this method facilitates gradient exposure of a mask pattern.

### CROSS REFERENCE TO RELATED APPLICATIONS

This application is related to and claims priority from U.S. provisional application 60/447,509 filed on Feb. 14, 2003, hereby incorporated by reference.

### FIELD OF THE INVENTION

The present invention relates to optical lithography.

### BACKGROUND

Optical lithography is a processing technique where a pattern is optically transferred from a photomask to a target. A typical target is a layer of photoresist on top of a semiconductor wafer. In many cases, optical lithography is used to define a critical dimension on the target, and this critical dimension has decreased to below 0.5 microns as lithography technology has evolved. Since optical lithography is a widely used technique, there is a substantial body of pertinent art. Much of this art is concerned with various methods of improving the fidelity of pattern transfer from photomask to target. For example, the use of a phase-shift photomask to improve contrast is one such development.

Given a high fidelity pattern transfer from photomask to target, a change in the desired target pattern generally requires creation of a new photomask. Although this requirement of a new photomask for each desired target pattern is often not unduly burdensome (e.g., in large scale production), it is indicative of a certain degree of inflexibility that necessarily follows from high fidelity pattern transfer from photomask to target.

For some applications of optical lithography, such as research and development, it is desirable to change the target pattern in a controllable manner without changing the photomask pattern. This flexibility is generally not provided by conventional optical lithography, as indicated above. Accordingly, it would be an advance in the art to provide such flexibility.

One example of such desired flexibility is gradient exposure of a mask pattern such that the resulting target pattern is non-uniformly exposed. A recent paper by Cao et al. (Applied Physics Letters, 81(16), pp 3058-3060, October 2002) demonstrates a method for gradient exposure where the photomask is non-uniformly illuminated, due to insertion of a blocking structure between the light source and photomask. Light diffraction from the edge of the blocking structure provides the non-uniform illumination of the mask.

The technique of Cao et al. has several disadvantages. Since the blocking structure and photomask are physically separated, it is difficult to align features in the blocking structure to features in the mask. Furthermore, the blocking structure of Cao et al. is inserted into the optical path between the light source and the photomask. Such insertion may be inconvenient or even impossible depending on the configuration of the lithography instrument being used.

Accordingly, there is an unmet need in the art for an optical lithography method providing improved pattern flexibility and ease of alignment which is also compatible with commonly used optical lithography equipment.

### SUMMARY

The present invention provides a method for performing optical lithography. Light is transmitted through a photomask to impinge on a target. The photomask has two mask patterns on two opposing mask surfaces separated by a transparent substrate. Light is transmitted through the first mask pattern and propagates to the second mask pattern, thereby forming a propagation pattern at that location. Light from the propagation pattern is transmitted through the second mask pattern and impinges on the target, thereby creating a target pattern. An advantage of the present invention is that the target pattern can be changed without changing either of the mask patterns. A further advantage of the present invention is that gradient exposure of a mask pattern is facilitated. The invention also provides ease of alignment of the first mask pattern to the second mask pattern, and compatibility with standard photolithography equipment.

### BRIEF DESCRIPTION OF THE DRAWINGS

FIG. 1a shows an optical lithography method according to an embodiment of the invention.

FIG. 1b shows an intensity distribution of a propagation pattern of the embodiment of FIG. 1a.

FIG. 2a shows an optical lithography method according to another embodiment of the invention.

FIG. 2b shows an intensity distribution of a propagation pattern of the embodiment of FIG. 2a.

### DETAILED DESCRIPTION

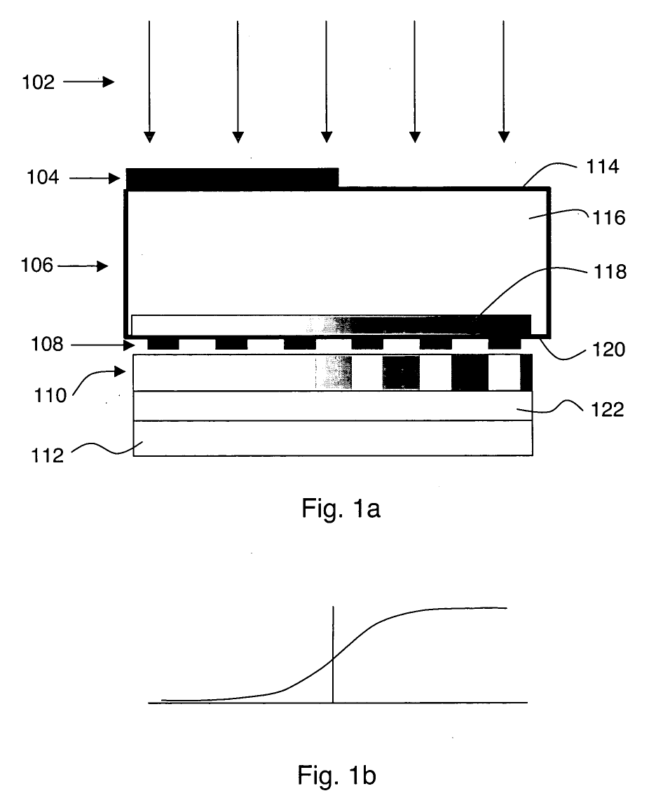

FIG. 1a shows an optical lithography method according to an embodiment of the invention. Light 102 is transmitted through a photomask 106 to impinge on a target 122. Photomask 106 has a first surface 114 and a second surface 120 on opposite sides of a transparent substrate 116. Transparent substrate 116 is preferably Schott Borofloat® glass, since this product has excellent surface finish and flatness, but any transparent material can be used for substrate 116. Substrate 116 preferably has a thickness from about 0.3 mm to about 5 mm, and more preferably is about 0.7 mm thick.

A first mask pattern 104 is disposed on first surface 114, and a second mask pattern 108 is disposed on second surface 120. The material of mask patterns 106 and 108 is preferably amorphous silicon having a thickness of about 150 nm, since amorphous silicon is easy to deposit uniformly, is compatible with CMOS processing, and is opaque to ultraviolet radiation. However, any opaque material, such as chromium or iron oxide, can also be used for mask patterns 106 and 108 to practice the invention. Mask pattern layer thicknesses other than 150 nm can also be used to practice the invention.

Light 102 is transmitted through first mask pattern 104, propagates to second surface 120, and forms a propagation pattern 118 at second surface 120. The optical intensity distribution of propagation pattern 118 depends in part on the distance between surfaces 114 and 120, the wavelength (or wavelengths) of light 102, and the geometry of first mask pattern 104. Light from propagation pattern 118 is transmitted through second mask pattern 108 to form target pattern 110, which impinges on target 122. Target 122 can be, for example, a film of photoresist on top of a semiconductor wafer 112. Target pattern 110 typically includes one or more features having a critical dimension which can be less than about 0.5 microns. Since mask patterns 104 and 108 are disposed on opposite sides of substrate 116, relative alignment of these two patterns can easily be provided, e.g., by use of known backside alignment procedures. This ease of alignment is one of the advantages provided by the invention.

In the embodiment of FIG. 1a, propagation pattern 118 preferably has a smooth, monotonic intensity distribution, as indicated by shading on FIG. 1a. FIG. 1b is a schematic plot of intensity vs. position for propagation pattern 118 of FIG. 1a. Such an intensity distribution is useful for performing gradient exposure of second mask pattern 108, since target pattern 110 is basically a combination of second mask pattern 108 with the monotonic intensity gradient established by propagation pattern 118. Thus diffraction fringes in propagation pattern 118 are undesirable in this embodiment.

For this reason, light 102 is preferably non-monochromatic light, since such light tends not to form diffraction fringes (or patterns). Non-monochromatic light 102 can include light having at least two discrete optical wavelengths, or can include light having substantially a continuous range of wavelengths. In either case, diffraction fringes in propagation pattern 118 are effectively removed by the presence of light at multiple wavelengths.

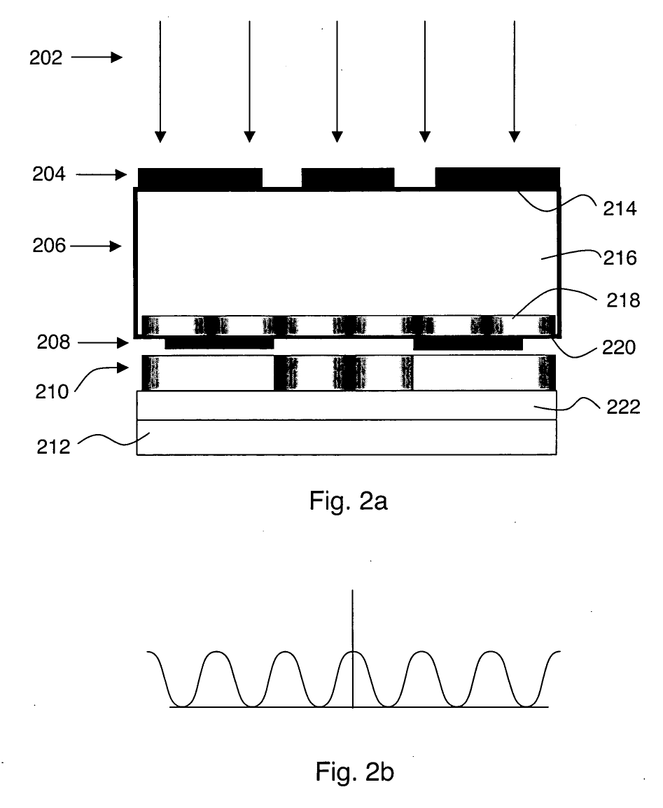

FIG. 2a shows an optical lithography method according to another embodiment of the invention. Light 202 is transmitted through a photomask 206 to impinge on a target 222. Mask 206 has a first surface 214 and a second surface 220 on opposite sides of a transparent substrate 216. Transparent substrate 216 is preferably Schott Borofloat® glass, since this product has excellent surface finish and flatness, but any transparent material can be used for substrate 216. Substrate 216 preferably has a thickness from about 0.5 mm to about 5 mm, and more preferably is about 0.7 mm thick.

A first mask pattern 204 is disposed on first surface 214, and a second mask pattern 208 is disposed on second surface 220. The material of mask patterns 206 and 208 is preferably amorphous silicon having a thickness of about 150 nm, but any opaque material, such as chromium or iron oxide, can also be used for mask patterns 206 and 208 to practice the invention. Mask pattern layer thicknesses other than 150 nm can also be used to practice the invention.

Light 202 is transmitted through first mask pattern 204, propagates to second surface 220, and forms a propagation pattern 218 at second surface 220. The optical intensity distribution of propagation pattern 218 depends in part on the distance between surfaces 214 and 220, the wavelength (or wavelengths) of light 202, and the geometry of first mask pattern 204. Light from propagation pattern 218 is transmitted through second mask pattern 208 to form target pattern 210, which impinges on target 222. Target 222 can be, for example, a film of photoresist on top of a semiconductor wafer 212. Target pattern 210 typically includes one or more features having a critical dimension which can be less than about 0.5 microns. Since mask patterns 204 and 208 are disposed on opposite sides of substrate 216, relative alignment of these two patterns can easily be provided, e.g., by use of known backside alignment procedures. This ease of alignment is one of the advantages provided by the invention.

In the embodiment of FIG. 2a, propagation pattern 218 has a periodic intensity distribution, as indicated by shading on FIG. 2a. FIG. 2b is a schematic plot of intensity vs. position for propagation pattern 218 of FIG. 2a. Target pattern 210 is basically a combination of second mask pattern 208 with propagation pattern 218, and as a result, the diffraction fringes of propagation pattern 218 are present in target pattern 210. In the example of FIG. 2a, first mask pattern 204 includes two closely spaced slits, and as a result, propagation pattern 218 is a double-slit diffraction pattern. Of course, other diffraction patterns can also be used to practice the invention, such as an Airy disk pattern (diffraction by a circular aperture) and a single-edge diffraction pattern. The spacing of the diffraction fringes in propagation pattern 218 can be altered by changing the wavelength of light 202, which allows target pattern 210 to be varied without altering either of mask patterns 204 or 208. Such flexibility in altering target pattern 210 is one of the advantages of the invention.

Since the embodiment of FIG. 2a relies on diffraction to form propagation pattern 218, light 202 is preferably substantially at a single wavelength, since diffraction effects are thereby maximized.

The embodiments of FIGS. 1a and 2a are exemplary, and the invention may be practiced in many other ways than the embodiments discussed above.

For example, first mask patterns, such as 104 and 204, can be fabricated from transparent materials, such as MgF₂, CaF₂, lithium niobate, silicon nitride, quartz or other glasses. A propagation pattern such as 118 or 218 can be formed by transmission of light through a first mask pattern of a transparent material. A transparent mask pattern operates by imposing a phase shift (relative to portions of the incident light unaffected by the mask) on selected portions of the incident light. This phase shift is preferably an odd multiple of π, but can take on any value which is not an integral multiple of 2π.

Similarly, second mask patterns, such as 108 and 208, can be fabricated from transparent materials, such as MgF₂, CaF₂, lithium niobate, silicon nitride, quartz or other glasses. A target pattern such as 110 or 210 can be formed by transmission of propagation pattern light through a second mask pattern of a transparent material, in a manner related to phase-shift lithography.

Also, the examples of FIGS. 1a and 2a show contact lithography, where second mask patterns such as 108 and 208 are in close proximity to the target. The invention can also be practiced with other forms of optical lithography, such as projection or stepper-based lithography.

What is claimed is:

1. A method for illuminating a target for optical lithography, the method comprising:
a) providing a photomask including:
i) a transparent substrate having first and second surfaces on opposite sides of said substrate, said second surface facing said target;
ii) a first mask pattern on said first surface; and
iii) a second mask pattern on said second surface;
b) transmitting an incident light through said first mask pattern to form a propagation pattern at said second surface; and
c) transmitting light from said propagation pattern through said second mask pattern to form a target pattern on said target.

2. The method of claim 1, wherein a critical dimension in said target pattern is less than about 0.5 microns.

3. The method of claim 1, wherein said first mask pattern comprises an opaque material.

4. The method of claim 3, wherein said opaque material comprises amorphous silicon, chromium or iron oxide.

5. The method of claim 1, wherein said first mask pattern comprises a transparent material.

6. The method of claim 6, wherein said transparent material comprises MgF₂, CaF₂, lithium niobate, silicon nitride, quartz or glass.

7. The method of claim 1, wherein said second mask pattern comprises an opaque material.

8. The method of claim 7, wherein said opaque material comprises amorphous silicon, chromium or iron oxide.

9. The method of claim 1, wherein said second mask pattern comprises a transparent material.

10. The method of claim 9, wherein said transparent material comprises MgF₂, CaF₂, lithium niobate, silicon nitride, quartz or glass.

11. The method of claim 1, wherein said substrate comprises glass.

12. The method of claim 1, wherein said substrate has a thickness separating said first and second surfaces in a range from about 0.3 mm to about 5 mm.

13. The method of claim 1, wherein said propagation pattern comprises a double slit optical diffraction pattern.

14. The method of claim 1, wherein said propagation pattern comprises an Airy disk optical diffraction pattern.

15. The method of claim 1, wherein said propagation pattern comprises a single edge optical diffraction pattern.

16. The method of claim 1, wherein said propagation pattern comprises a monotonic optical intensity distribution.

17. The method of claim 1, wherein said incident light is substantially at a single wavelength.

18. The method of claim 1, wherein said incident light is substantially at a plurality of wavelengths.

19. The method of claim 1, wherein said incident light comprises light at substantially a continuous range of wavelengths.

20. The method of claim 1, wherein said second mask pattern is in proximity to said target.
